(19) United States
(12) Patent Application Publication
(10) Pub. No.: US 2025/0085019 A1
(43) Pub. Date: Mar. 13, 2025

(54) FLUID HEATING DEVICE FOR BATTERY HEATING OF ELECTRIC VEHICLE

(71) Applicant: KOREA FUEL-TECH CORPORATION, Anseong-si (KR)

(72) Inventors: Ki Hong KIM, Anseong-si (KR); Dong Chul Lee, Hwaseong-si (KR); Seung Jin Yang, Anseong-si (KR)

(21) Appl. No.: 18/825,727

(22) Filed: Sep. 5, 2024

(30) Foreign Application Priority Data
Sep. 11, 2023 (KR) 10-2023-0120272

(51) Int. Cl. F24H 1/00; B60L 58/27; F24H 15/128; H01M 10/615; H01M 10/625; H01M 10/6567

(52) U.S. Cl. CPC F24H 1/009; F24H 15/128; H01M 10/615; H01M 10/625; H01M 10/6567; B60L 58/27; H01M 2220/20

(57) ABSTRACT

In order to provide a fluid heating device for battery heating of an electric vehicle to ensure durability of a heating device and prevent malfunction of the device due to submersion, a fluid heating device for battery heating of an electric vehicle of the present disclosure includes a housing configured to allow fluid to flow in and out and form a first space in which the fluid is heated, and a heater configured to form a path through which the fluid flows into the first space and heat the fluid.

### CROSS REFERENCE TO RELATED APPLICATION

This application claims priority from Korean Patent Application No. 10-2023-0120272, filed on Sep. 11, 2023, which is hereby incorporated by reference in its entirety.

### BACKGROUND

### Field

The present disclosure relates to a fluid heating device for an electric vehicle, and more specifically, to a fluid heating device for battery heating of an electric vehicle to secure battery performance of the electric vehicle.

### Related Art

Generally, an electric vehicle is operated based on a battery mounted on the vehicle. When an external temperature drops, the performance of the battery may deteriorate. In order to secure the performance of the battery, a battery heating system is required. The heating system heats the fluid and increases the temperature of the battery using the heated fluid.

The heating system is equipped with a heating device that heats the fluid. The related art regarding the heating device is disclosed by “Korean Patent No. 10-2366917 (Battery Heating Device for Electric Vehicle, Jul. 10, 2018)”. The above-mentioned registered invention includes a housing through which fluid flows in and out, and a heater that is arranged inside the housing and heats the fluid.

When a heating device is operated for a long period of time, internal components may experience deterioration due to fluid contact and heat. In particular, the heating device had a problem in that a leak occurred due to deterioration at a part where each component, such as the housing and the heater, is connected.

### SUMMARY

A purpose of the present disclosure is to provide a fluid heating device for battery heating of an electric vehicle that secures the durability of the heating device and prevents malfunction of the device due to submersion.

According to an aspect of the present disclosure, there is provided a fluid heating device for battery heating of an electric vehicle, the fluid heating device including: a housing configured to allow fluid to flow in and out and form a first space in which the fluid is heated; and a heater configured to form a path through which the fluid flows into the first space and heat the fluid, in which wherein the heater includes a support section arranged inside the housing and configured to form a second space separated from the first space, a heating section connected to the support section with an adhesive, having at least a portion extending into the first space, forming a path through which the fluid flows into the first space, and configured to heat the fluid, and a head section connected to the heating section with the adhesive and configured to form a path through which the fluid is supplied to the heating section.

The housing may include a first housing including one surface open and a first region extending from an inner wall and configured so that the support section is arranged, and a second housing configured to close the open surface of the first housing and including a pressurizing section extending toward the support portion to press the support section toward the first region.

The first housing may include a second region extending outwardly from a side wall and arranged so that at least a portion of the second housing is in surface contact, and a third region provided to surround an edge of the second housing at an end of the second region, and a connecting member penetrating the third region to be inserted into the edge of the second housing and connecting the first housing and the second housing may be provided in the third region.

The second housing may include a connection section formed on a surface adjacent to the second region and inserted into a hole formed in the second region to connect the second housing to the first housing.

The heating section may include a first tube provided to allow the fluid to enter an inside thereof, a second tube provided to surround an outer surface of the first tube, and a heating module provided between the first tube and the second tube to generate heat, and the first tube and the second tube may be at least partially broken when the heating module exceeds a preset temperature and generates heat, thereby preventing overheating of the heating module.

The fluid may flow into the first space along an inner surface of the first tube and flow out from the first space along an outer surface of the second tube.

The fluid heating device may further include a filter section configured to prevent foreign substances from flowing out together with the fluid from an inside of the housing.

The filter section may include a filter member configured to filter the foreign substances from the fluid, and a filter support member provided to surround at least a portion of the inner wall of the housing and configured to support the filter member in the first space.

The housing may include a protrusion protruding inwardly from the inner wall at a location adjacent to the support section, and at least a part of the filter support section may be supported by being arranged between the support section and the protrusion.

The adhesive may include a glass fit.

The fluid heating device for battery heating of an electric vehicle according to the present disclosure has the following effects.

First, the present disclosure has the effect of preventing malfunction of the heating device due to leakage.

Second, the present disclosure has the effect of securing durability and extending the life of the heating device.

The technical effects of the present disclosure as described above are not limited to the effects mentioned above, and other technical effects not mentioned can be clearly understood by those skilled in the art from the description below.

### BRIEF DESCRIPTION OF THE DRAWINGS

FIG. 1 is a perspective view illustrating a fluid heating device for battery heating of an electric vehicle according to the present embodiment.

FIG. 2 is a cross-sectional view illustrating the fluid heating device for battery heating of an electric vehicle taken along I-I′ of FIG. 1.

FIG. 3 is an enlarged view of a part “A” of FIG. 2.

FIG. 4 is a cross-sectional view illustrating the fluid heating device for battery heating of an electric vehicle taken along II-II′ of FIG. 1.

FIG. 5 is an exploded perspective view of a heater.

FIG. 6 is an exploded perspective view of a tube.

FIG. 7 is a flow chart illustrating an operation sequence of the fluid heating device for battery heating of an electric vehicle according to the present embodiment.

### DESCRIPTION OF EXEMPLARY EMBODIMENTS

Hereinafter, an embodiment of the present disclosure will be described in detail with reference to the attached drawings. However, the present embodiment is not limited to the embodiments disclosed below, but can be implemented in various forms, and the present embodiment is provided only to completely disclose the present disclosure and to completely inform a person having ordinary knowledge of the scope of the disclosure. The shapes of elements in the drawings may be exaggerated for a clearer explanation, and elements indicated by the same symbols in the drawings mean the same elements.

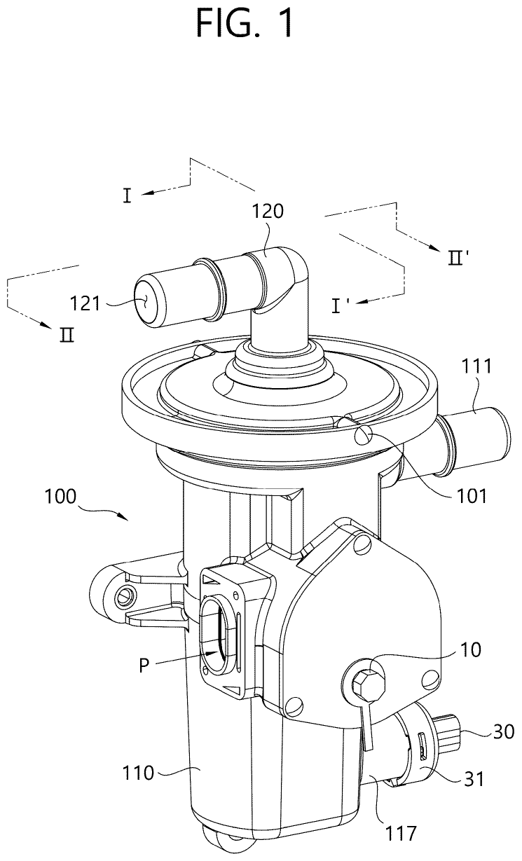

FIG. 1 is a perspective view illustrating a fluid heating device for battery heating of an electric vehicle according to the present embodiment.

As illustrated in FIG. 1, a fluid heating device (1000, hereinafter referred to as “heating device”) of an electric vehicle according to the present embodiment is configured so that fluid F can flow in and flow out. Here, the fluid F includes a coolant used in the vehicle, but the type of fluid F is not limited.

The heating device 1000 forms a space in which fluid F flows in and accommodated for a predetermined period of time. Then, the heating device 1000 heats the introduced fluid F. The heated fluid F flows out from the heating device 1000 toward a battery of the electric vehicle. Accordingly, the fluid F can heat the battery of the electric vehicle.

The heating device 1000 is provided with a cable fastening port P to which a power cable for power supply is connected. In addition, the heating device 1000 is provided with a ground screw 10 to prevent leakage current that may occur during operation, and a ground wire is connected to the ground screw 10 to allow leakage current to flow to the outside.

In addition, the heating device 1000 is provided with a temperature sensor 30 for measuring the temperature of the fluid F. The temperature sensor 30 may provide the measured temperature of the fluid F to a control system that controls the heating device 1000.

Meanwhile, the configuration of the heating device 1000 according to the present embodiment will be described below with reference to the attached drawings.

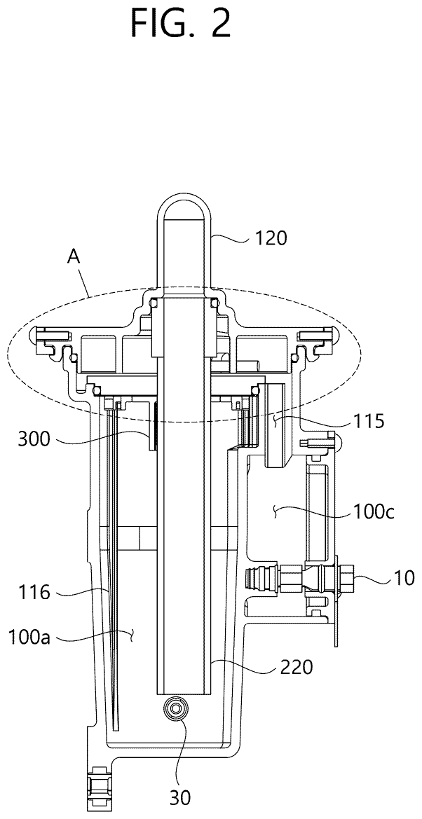

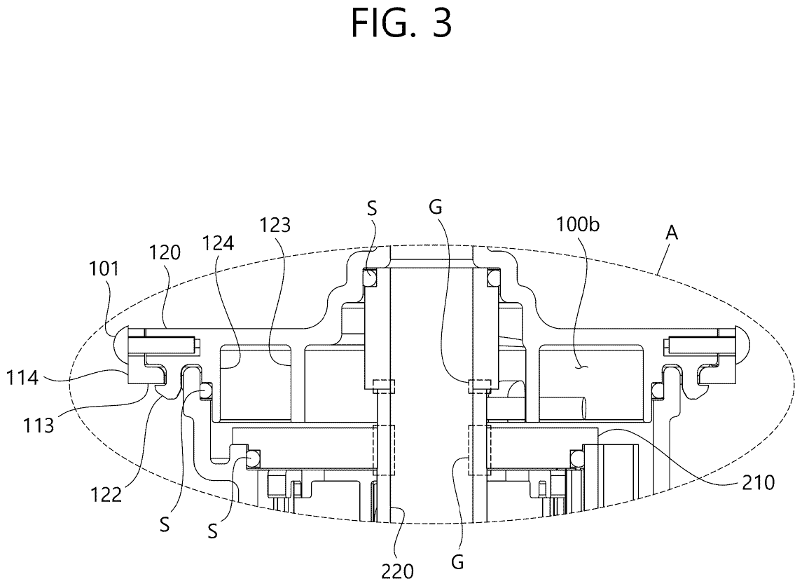

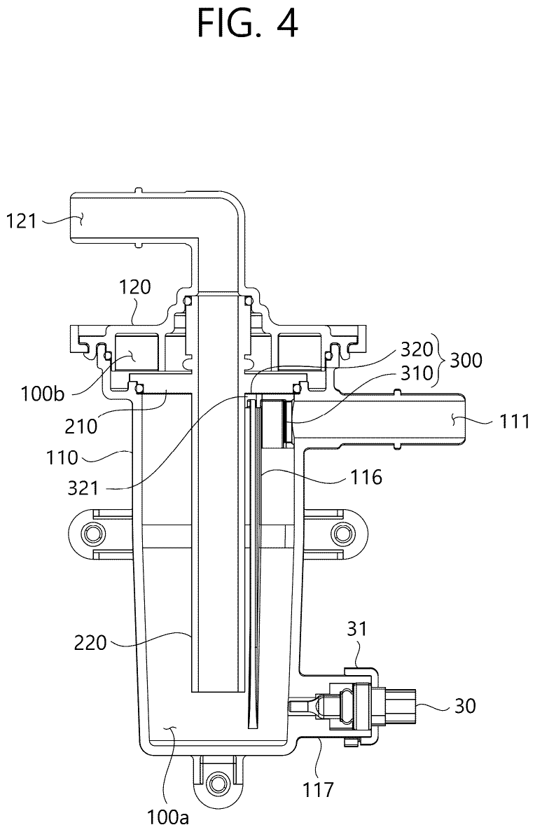

FIG. 2 is a cross-sectional view illustrating a fluid heating device for battery heating of an electric vehicle taken along I-I′ of FIG. 1, and FIG. 3 is an enlarged view of a part “A” of FIG. 2. Moreover, FIG. 4 is a cross-sectional view illustrating the fluid heating device for battery heating of an electric vehicle cut taken along II-II′ of FIG. 1.

As illustrated in FIGS. 2 to 4, the heating device 1000 according to the present embodiment may include a housing 100, a heater 200, and a filter section.

First, the housing 100 forms a space in which fluid F and some components of the heating device 1000 are accommodated. The housing 100 may be divided into a first space 100a, a second space 100b, and a third space 100c. The first space 100a is a space where fluid F flows in and out. The second space is separated from the first space 100a by a support section 210 described later, and is a space where a part of a wire that supplies power to the heater 200 is placed. The third space 100c communicate with the second space 10b and is a space where another part of the wire is placed. A part of the ground screw 10 described above is placed in the third space 100c to allow leakage current to flow to the outside. The housing 100 may be made of a thermoplastic material and may be manufactured through a casting process.

For example, the housing 100 may include a first housing 110 and a second housing 120.

The first housing 110 may be provided in a form in which one surface is open. The first housing 110 may form the first space 100a, the second space 100b, and the third space 100c described above.

For example, the first housing 110 may include an outlet 111, a first region 112, a second region 113, a third region 114, a fourth region 115, a sensor fastening section 116, and a protrusion 117.

The outlet 111 is formed on the inner wall of the first housing 110. The outlet 111 heats the fluid F flowing into a first space 100a and discharges the fluid to the outside. Here, the outlet 111 may be formed at a position where the fluid F maximizes a residence time thereof in the first space 100a.

The first region 112 is formed by extending from the inner wall of the first housing 110. The support section 210 is arranged in the first region 112. Here, the support section 210 may separate the first space 100a and the second space 100b. A sealing member S is provided between the first region 112 and the support section 210 so that fluid communication between the first space 100a and the second space 100b can be blocked.

The second region 113 is formed by extending the inner wall of the first housing 110 in an outward direction. At least a part of the second housing 120 may be closely attached to the second region 113.

The third region 114 is provided to extend from the end of the second region 113 and surround the edge of the second housing 120 arranged in the second region 113. A hole through which a connecting member 101 passes is formed in the third region 114. Here, the connecting member 101 may be inserted into the edge of the second housing 120 by penetrating the third region 114.

The fourth region 115 is provided so that the second space 100b and the third space 100c communicate with each other. Accordingly, the wire connected to the heater 200 may be arranged to extend from the third space 100c to the second space 100b. Moreover, the wire can provide power to the heater 200 from a power supply cable connected to the cable fastening hole P.

The sensor fastening section 116 is formed on the outer surface of the first housing 110 so that the temperature sensor 30 is supported by the first housing 110. The sensor fastening section 116 may be formed to protrude in the outer direction of the first housing 110. The sensor fastening section 116 forms a space in which the temperature sensor 30 is inserted inside. Moreover, in the sensor fastening section 116, a hole communicating with the first space 100a is formed, and a part of the temperature sensor 30 is inserted into the formed hole and arranged in the first space 100a. Therefore, the temperature sensor 30 may contact the fluid F accommodated in the first space 100a and measure the temperature of the fluid F.

Moreover, a detachment prevention member 31 that prevents the temperature sensor 30 from being detached may be installed in the sensor fastening section 116 by forming a protrusion on the outside. The detachment prevention member 31 is connected to the protrusion while wrapping around another part of the temperature sensor 30 inserted in the sensor fastening section 116. Therefore, the detachment prevention member 31 may support the temperature sensor 30 by the sensor fastening section 116 to prevent the detachment.

The sensor fastening section 116 is preferably formed at a position separated from the heater 200 so that interference by the heat of the heater 200 is minimized when the temperature sensor 30 measures the temperature of the fluid F.

The protrusion 117 is provided to protrude inwardly on the inner wall of the first housing 110. The protrusion 117 is described below as a configuration for supporting a filter section 300.

The second housing 120 is connected to the first housing 110 and closes the open surface of the first housing 110. For example, the second housing 120 may include an inlet 121, a connection section 122, a pressurizing section 123, and an entrance 124.

The inlet 121 allows fluid F to flow into the interior of the housing 100.

The connection section 122 is provided on the surface of the second housing 120 adjacent to the second region 113. The connection section 122 is inserted into a hole formed in the second region 113. In addition, the connection section 122 is provided in a form in which the end is bent to support the second housing 120 by the first housing 110.

Here, the connecting member 101 and the connection section 122 may prevent the second housing 120 from being detached. For example, when the surface of the second housing 120 adjacent to the first housing 110 is provided in a circular shape, the connecting member 101 and the connection section 122 can prevent the second housing 120 connected to the first housing 120 from being rotated.

The pressurizing section 123 is provided to extend from the second housing 120 toward the support section 210 arranged in the first region 112. The pressurizing section 123 may pressurize the support section 210 toward the first region 112 side by connecting the second housing 120 to the first housing 110. The pressurizing section 123 may support the support section 210 by the first region 112 and the support section 210 may strengthen fluid communication blocking between the first space 100a and the second space 100b.

The entrance 124 is arranged to be in close contact with the inner wall of the first housing 110 when the second housing 120 is connected to the first housing 110. Moreover, a sealing member S is provided between the entrance 124 and the inner wall of the first housing 110, so that fluid communication between the outside air and the second space 100b can be blocked.

Meanwhile, the heater 200 is placed inside the housing 100. The heater 200 extends from the second space 100b to the first space 100a. The heater 200 generates heat based on power supplied from a wire to heat the fluid F.

For example, the heater 200 may include the support section 210, a heating section 220, and a head section 230. The heater 200 may be connected to the support section 210, the heating section 220, and the head section 230 by adhesive. Here, the adhesive can be applied between the support section 210 and the heating section 220 and between the heating section 220 and the head section 230 (see “G” in FIG. 3).

The adhesive can be prepared as a glass frit including SiO₂ and Al₂O₃. The adhesive may be applied to the above-mentioned connection portion G and, through a high-temperature firing process, connect the support section 210 and the heating section 220, and the heating section 220 and the head section 230. The adhesive may improve the heat resistance and durability of the heater 200, thereby minimizing the leak that may occur at the connection portion G. Therefore, the heater 200 according to the present embodiment can prevent the leakage of fluid F even when operated for a long period of time by securing heat resistance and durability, and thus, the stability of the heating device 1000 can be secured.

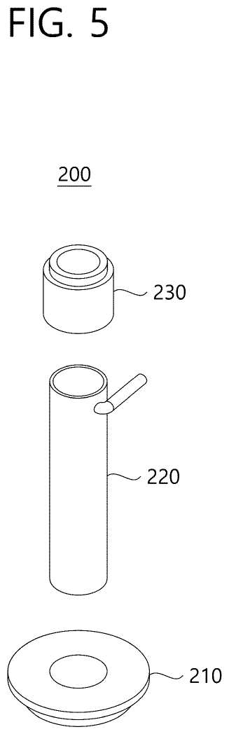

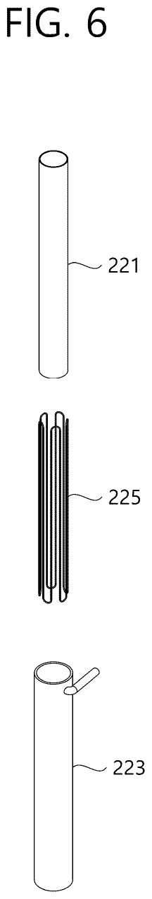

Here, the configuration of the heater 200 according to the present embodiment will be described with reference to FIGS. 5 and 6.

FIG. 5 is an exploded perspective view of the heater, and FIG. 6 is an exploded perspective view of the tube.

As illustrated in FIGS. 5 and 6, the heater 200 according to the present embodiment may include the support section 210, the heating section 220, and the head section 230.

As described above, the support section 210 is arranged in the first region 112 to separate the first space 100a and the second space 100b. Moreover, the support section 210 supports the heating section 220.

The heating section 220 extends from the second space 100b to the first space 100a. The heating section 220 forms a path through which the fluid F flows into the first space 100a. In addition, the heating section 220 heats the fluid F by generating heat based on the power supplied from the wire.

For example, the heating section 220 may include a first tube 221, a second tube 223, and a heating module 225.

The first tube 221 is provided so that fluid can flow into the inside. The second tube 223 is provided so as to surround the outer surface of the first tube 221. The heating module 225 is provided between the first tube 221 and the second tube 223. Here, a portion between the first tube 221 and the second tube 223 is configured so that fluid communication with the outside is blocked to prevent leakage of the heating module 225.

The heating section 220 heats the fluid F adjacent to the inner side of the first tube 221 and the outer side of the second tube 223 by generating heat from the heating module 225. The heating section 220 may be arranged on a central axis penetrating the first space 100a and the second space 100b to efficiently heat the fluid F. However, there is no limitation on the position of the heating section 220.

Moreover, the heating section 220 is configured to prevent overheating of the heating module 225. For example, the first tube 221 and the second tube 223 may be made of a ceramic material. Moreover, the first tube 221 and the second tube 223 may have a thickness that is damaged when heated to a preset temperature. Therefore, when the heating module 225 is overheated, at least a part of the first tube 221 and the second tube 223 may be damaged. Due to this, the fluid F enters between the first tube 221 and the second tube 223, power to the heating module 225 is cut off, and thus heat generation of the heating module 225 is stopped, thereby preventing overheating.

The head section 230 is connected to the heating section 220 to form a path through which the fluid F moves to the heating section 220. The head section 230 may be provided in a tube shape. The head section 230 is arranged in the second space 100b and is in close contact with the second housing 120. In addition, the sealing member S is provided between the second housing 120 and the head section 230, so that the fluid F can be prevented from leaking into the second space 100b during the process of being introduced.

As illustrated in FIGS. 2 to 4 again, the filter section 300 according to the present embodiment is arranged inside the first housing 110. The filter section 300 prevents foreign substances from leaking out through the outlet 111. The filter section 300 can filter the foreign substances that may be generated from the housing 100 and/or the heater 200 during the long-term operation of the heating device 1000. In addition, the filter section 300 can filter debris generated from the first tube 221 and/or the second tube 223 when the first and second tubes are damaged in order to prevent overheating of the heater 200.

For example, the filter section 300 may include a filter member 310 and a filter support member 320.

The filter member 310 is provided so that foreign substances of a predetermined size are filtered. The filter member 310 may be arranged adjacent to the outlet 111. In addition, the filter member 310 may be formed with a slit-shaped hole having a predetermined width.

The filter support member 320 supports the filter member 310 inside the first housing 110. The filter support member 320 may be provided to surround the inner wall of the first housing 110. At least a portion of the filter support member 320 may be arranged to be supported by the protrusion 117. Here, the protrusion 117 may be formed to be partially adjacent to the support section 210. That is, the filter support member 320 may be supported by the protrusion 117 in a state of being in contact with the support section 210. In addition, a support protrusion 321 is formed in the filter support member 320 to span the protrusion 117. Accordingly, the filter support member 320 may be supported by the support protrusion 321 spanning the protrusion 117 and may be prevented from being separated, such as from being rotated, within the first housing 110.

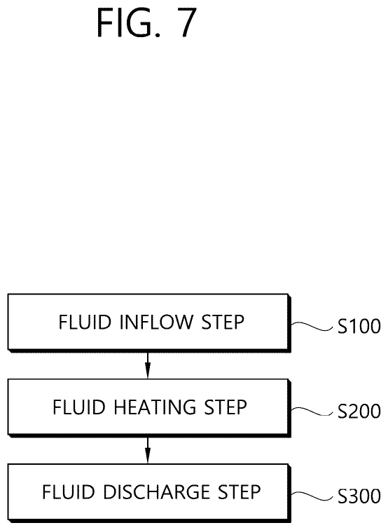

Meanwhile, the operation of the heating device 1000 will be described below with reference to FIG. 7. The operation of the heating device 1000 described below can be understood with reference to FIG. 4.

FIG. 7 is a flowchart illustrating an operation sequence of the fluid heating device for battery heating of an electric vehicle according to the present embodiment.

As illustrated in FIG. 7, the heating device 1000 according to the present embodiment may heat the fluid F and perform the battery heating through a fluid inflow step S100, a fluid heating step S200, and a fluid discharge step S300.

First, in the inflow step S100, the heating device 1000 may be operated when the external temperature of the electric vehicle is lower than the preset temperature. The fluid F may flow into housing 100 through the inlet 121 as the fluid circulates in the heating system.

Then, in the fluid heating step S200, the fluid F passes through the head section 230 and enters the interior of the heating section 220. In this case, the fluid F may be heated while coming into contact with the first tube 221. Moreover, the fluid F flows into the first space 100a and moves toward the bottom surface of the first housing 110. In this case, the temperature sensor 30 measures the temperature of the fluid F flowing into the first space 100a. The temperature sensor 30 provides the measured temperature of the fluid F to the outside.

Here, when the heater 200 overheats due to a malfunction of the heating module 225, a part of the heating section 220 may be damaged, thereby preventing overheating of the heating module 225.

Moreover, in the fluid discharge step S300, the heated fluid F may flow out through the outlet 111 and be supplied to the vehicle battery side. In this case, the filter section 300 blocks foreign substances from flowing out together with the fluid F, thereby preventing damage or errors in the heating system caused by foreign substances. Meanwhile, the fluid F supplied to the vehicle battery side can heat up the vehicle battery, thereby securing the performance of the vehicle battery.

In this way, the electric vehicle heating device 1000 according to the present disclosure can heat the fluid for heating up the battery. In addition, the present disclosure can secure heat resistance and durability of the heater to prevent leakage, and can secure the stability of the heating system by preventing foreign substances from flowing out of the heating system.

Accordingly, the present disclosure includes the effect of preventing malfunction of the heating device due to leakage.

In addition, the present disclosure includes the effect of securing durability to extend the life of the heating device.

The embodiments of the present disclosure described above and illustrated in the drawings should not be construed as limiting the technical idea of the present disclosure. The protection scope of the present disclosure is limited only by the matters described in the claims, and a person having ordinary knowledge in the technical field of the present disclosure can improve and change the technical idea of the present disclosure in various forms. Accordingly, such improvements and modifications will fall within the scope of protection of the present disclosure as long as they are obvious to a person having ordinary skill in the art.

What is claimed is:

1. A fluid heating device for battery heating of an electric vehicle, the fluid heating device comprising:
a housing configured to allow fluid to flow in and out and form a first space in which the fluid is heated; and
a heater configured to form a path through which the fluid flows into the first space and heat the fluid,
wherein the heater includes:
a support section arranged inside the housing and configured to form a second space separated from the first space;
a heating section connected to the support section with an adhesive, having at least a portion extending into the first space, forming a path through which the fluid flows into the first space, and configured to heat the fluid; and
a head section connected to the heating section with the adhesive and configured to form a path through which the fluid is supplied to the heating section.

2. The fluid heating device of claim 1, wherein the housing includes:
a first housing including one surface open and a first region extending from an inner wall and configured so that the support section is arranged; and
a second housing configured to close the open surface of the first housing and including a pressurizing section extending toward the support portion to press the support section toward the first region.

3. The fluid heating device of claim 2, wherein the first housing includes:
a second region extending outwardly from a side wall and arranged so that at least a portion of the second housing is in surface contact;
a third region provided to surround an edge of the second housing at an end of the second region; and
a connecting member penetrating the third region to be inserted into the edge of the second housing and connecting the first housing and the second housing is provided in the third region.

4. The fluid heating device of claim 3, wherein the second housing includes a connection section formed on a surface adjacent to the second region and inserted into a hole formed in the second region to connect the second housing to the first housing.

5. The fluid heating device of claim 2, wherein the heating section includes:
a first tube provided to allow the fluid to enter an inside thereof;
a second tube provided to surround an outer surface of the first tube; and
a heating module provided between the first tube and the second tube to generate heat,
wherein the first tube and the second tube are at least partially broken when the heating module exceeds a preset temperature and generates heat, thereby preventing overheating of the heating module.

6. The fluid heating device of claim 5, wherein the fluid flows into the first space along an inner surface of the first tube and flows out from the first space along an outer surface of the second tube.

7. The fluid heating device of claim 1, further comprising a filter section provided between the support section and a protrusion provided on the inner wall of the housing and configured to prevent foreign substances from flowing out together with the fluid from an inside of the housing.

8. The fluid heating device of claim 7, wherein the filter section includes:
a filter member configured to filter the foreign substances from the fluid; and
a filter support member provided to surround at least a portion of the inner wall of the housing and configured to support the filter member in the first space.

9. The fluid heating device of claim 8, wherein the filter support member includes a support protrusion provided to surround at least a portion of the protrusion and configured to prevent the filter support member from being detached.

10. The fluid heating device of claim 1, wherein the adhesive includes a glass fit.
